(19) United States
(12) Patent Application Publication
(10) Pub. No.: US 2026/0196522 A1
(43) Pub. Date: Jul. 9, 2026

(54) ANODE ACTIVE MATERIAL FOR SECONDARY BATTERY

(71) Applicants: SK ON CO., LTD., Seoul (KR); INDUSTRY-ACADEMIC COOPERATION FOUNDATION, YONSEI UNIVERSITY, Seoul (KR)

(72) Inventors: Han Vin KIM, Daejeon (KR); Sung Kyung KIM, Daejeon (KR); Jae Woo LEE, Daejeon (KR); Jae Chan RYU, Daejeon (KR); Seo Hyeon PARK, Daejeon (KR); Yoon Seok JUNG, Seoul (KR); Seung Goo JUN, Gyeonggi-do (KR); Eun Suh LEE, Seoul (KR)

(21) Appl. No.: 19/183,444

(22) Filed: Apr. 18, 2025

(30) Foreign Application Priority Data
Apr. 19, 2024 (KR) 10-2024-0052703
Apr. 1, 2025 (KR) 10-2025-0042253

(51) Int. Cl. H01M 4/62; C01B 33/02; H01M 4/02; H01M 4/134; H01M 4/36; H01M 4/38; H01M 10/0525

(52) U.S. Cl. CPC H01M 4/628; C01B 33/02; H01M 4/134; H01M 4/366; H01M 4/386; H01M 10/0525; C01P 2002/72; C01P 2002/85; C01P 2004/03; C01P 2004/61; C01P 2004/80; C01P 2006/40; H01M 2004/027

(57) ABSTRACT

An anode active material for a secondary battery according to the present disclosure includes a composite particle including a core containing silicon and metal nanoparticles arranged on an outer surface of the core. A ratio of the volume of the metal nanoparticles to the volume of the core is greater than 0.22 and 0.4 or less.

### CROSS REFERENCE TO RELATED APPLICATION

The present application claims priority to Korean Patent Application No. 10-2024-0052703, filed on Apr. 19, 2024, and Korean Patent Application No. 10-2025-0042253, filed on Apr. 1, 2025, the entire contents of which are incorporated herein for all purposes by this reference.

### BACKGROUND OF THE INVENTION

### 1. Field of the Invention

The present disclosure relates to an anode active material for a secondary battery, a method of preparing the same, an anode for a secondary battery, and a lithium secondary battery including the anode.

### 2. Description of the Related Art

A secondary battery is a battery that can be repeatedly charged and discharged. With rapid progress of information and communication technology and display industries, the secondary battery has been widely applied to various portable electronic telecommunication devices such as a camcorder, a mobile phone, a laptop computer, etc. as their power sources. Recently, a battery pack including the secondary battery has also been developed and applied to eco-friendly automobiles such as an electric vehicle, a hybrid vehicle, etc., as their power sources.

Examples of the secondary battery may include a lithium secondary battery, a nickel-cadmium battery, a nickel-hydrogen battery and the like. Among them, the lithium secondary battery has a high operating voltage and a high energy density per unit weight, making it advantageous in terms of charging speed and lightweight design. In this regard, the lithium secondary battery has been actively developed and applied to various industrial fields.

Since commercially available lithium secondary batteries mainly use liquid electrolytes until now, there are safety problems such as leakage, ignition, and explosion due to sudden environmental changes, including temperature fluctuations, external impacts and the like. To address these problems, attempts are being made to solidify the electrolyte, thereby enhancing stability and increasing energy density.

All-solid-state batteries may include solid-state electrolytes such as gel polymers, oxides, sulfides, or composite polymers as the electrolyte. Accordingly, stability against ignition and explosion caused by external impacts or external environmental fluctuations may be enhanced.

In order to commercialize a high-capacity all-solid-state battery with high energy density, it is preferable that the anode possesses both high capacity and enhanced electrochemical stability. To increase the capacity and enhance stability of the anode, a method using a silicon-based active material in combination with a solid electrolyte, a binder, a conductive material, etc. has been proposed. However, since the electrochemical properties of the anode have not been sufficiently improved, an alternative approach is needed.

### SUMMARY OF THE INVENTION

An object of the present disclosure is to provide an anode active material for a secondary battery having improved electrochemical properties.

Another object of the present disclosure is to provide a method of preparing the anode active material for a secondary battery.

In addition, another object of the present disclosure is to provide an anode for a secondary battery including the anode active material for a secondary battery.

Further, another object of the present disclosure is to provide a lithium secondary battery.

An anode active material for a secondary battery according to the present disclosure includes: a composite particle including a core including silicon and metal nanoparticles arranged on an outer surface of the core. A ratio of a volume of the metal nanoparticles to a volume of the core is greater than 0.22 and 0.4 or less.

According to exemplary embodiments, the ratio of the volume of the metal nanoparticles to the volume of the core may be 0.23 to 0.4.

According to exemplary embodiments, the volume of the core may be 75% by volume or more and 82% by volume or less based on the total volume of the composite particle.

According to exemplary embodiments, the volume of the metal nanoparticles may be greater than 18% by volume and 25% by volume or less based on the total volume of the composite particle.

According to exemplary embodiments, the metal nanoparticles may include at least one selected from the group consisting of silver (Ag), tin (Sn), aluminum (Al), bismuth (Bi), gold (Au), zinc (Zn), magnesium (Mg), antimony (Sb), lead (Pb) and indium (In).

According to exemplary embodiments, the metal nanoparticles may have a median particle diameter (D50) of 10 nm to 200 nm.

According to exemplary embodiments, the core may have a median particle diameter (D50) of 1 μm to 5 μm.

In accordance with a method of preparing an anode active material for a secondary battery according the present disclosure, a silicon-containing core particle is introduced into an acid solution to perform surface etching. The surface-etched core particle is introduced into an aqueous metal precursor solution to form metal nanoparticles on a surface of the core particle. A ratio of a volume of the metal nanoparticles to the volume of the core is greater than 0.22 and 0.4 or less.

According to exemplary embodiments, the surface etching may be performed for 2 minutes to 20 minutes.

According to exemplary embodiments, a pH of the acid solution may be 1 to 2.

According to exemplary embodiments, the acid solution may include at least one selected from the group consisting of hydrofluoric acid, nitric acid, hydrochloric acid, sulfuric acid, phosphoric acid and acetic acid.

According to exemplary embodiments, the metal precursor may include at least one selected from the group consisting of a metal nitrate, a metal sulfate, a metal hydroxide, and a metal chloride.

An anode for a secondary battery according to the present disclosure includes: an anode current collector; and an anode active material layer disposed on one surface of the anode current collector and including the above-described anode active material for a secondary battery and a binder.

According to exemplary embodiments, the anode active material layer may not include a carbon-based conductive material.

A lithium secondary battery according to the present disclosure includes: the above-described anode for a secondary battery; a cathode disposed to face the anode; and a solid electrolyte layer interposed between the anode and the cathode.

The anode active material for a secondary battery according to exemplary embodiments of the present disclosure may exhibit improved electrical conductivity and reduced resistance. Accordingly, the anode including the anode active material may exhibit high electrical conductivity, and a battery having improved performance may be provided.

The anode active material for a secondary battery according to exemplary embodiments of the present disclosure may have a low volume change rate during battery charging and discharging. Accordingly, the durability of the anode including the anode active material may be improved, an increase in internal pressure within the battery including the anode may be suppressed, and the cycle life characteristics of the battery may be enhanced.

The anode active material for a secondary battery according to exemplary embodiments of the present disclosure may suppress the decomposition of a solid electrolyte. Accordingly, fewer byproducts that impair the battery performance may be generated, and the cycle life characteristics of the battery may be improved.

The method of preparing an anode active material for a secondary battery according to exemplary embodiments of the present disclosure may form metal nanoparticles on the surface of the silicon-containing core particle by electroless plating.

The anode for a secondary battery according to exemplary embodiments of the present disclosure and the lithium secondary battery including the anode may exhibit high capacity, excellent stability, and improved cycle life characteristics.

The anode active material for a secondary battery, the anode for a secondary battery, and the lithium secondary battery of the present disclosure may be widely applied in green technology fields, such as electric vehicles, battery charging stations, as well as solar power generation, wind power generation, and the like, which use the batteries. In addition, the anode active material for a secondary battery, the anode for a secondary battery, and the lithium secondary battery of the present disclosure may be used in eco-friendly electric vehicles, hybrid vehicles, and the like, which are aimed at mitigating climate change by reducing air pollution and greenhouse gas emission.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is scanning electron microscope (SEM) images illustrating anode active materials of Example 1 and Comparative Example 1, and elemental EDS mapping images of silicon and silver;

FIG. 2 is SEM images illustrating the anode of Example 1 before and after compression;

FIG. 3 is a graph illustrating X-ray diffraction (XRD) analysis results of the anode active material of Example 1;

FIG. 4 is a graph illustrating electrical conductivity and surface resistance of the anodes of Example 1 and Comparative Example 2;

FIG. 5 is a graph illustrating discharge capacity according to the number of cycles of the all-solid-state half-cells of Example 1 and Comparative Examples 3 to 5;

FIG. 6 is a graph illustrating discharge capacity according to the number of cycles of the half-cells of Examples 1 to 3;

FIG. 7 is a graph illustrating capacity-voltage curves of the all-solid-state half-cells of Example 1 and Comparative Example 6;

FIG. 8 is a graph illustrating rate evaluation results according to the number of cycles of the all-solid-state half-cells of Example 1 and Comparative Example 6;

FIG. 9 is a graph illustrating the discharge capacity and coulombic efficiency according to the number of cycles of the all-solid-state half-cells of Example 1 and Comparative Example 6;

FIG. 10 is graphs illustrating XPS analysis results of the surface of the solid electrolyte layer after the cycle life characteristic evaluation of the solid electrolyte layers and the all-solid-state half-cells of Example 1 and Comparative Example 6;

FIGS. 11 and 12 show SEM cross-sectional images and EDS analysis results of the anode-solid electrolyte assemblies of Example 1 and Comparative Example 6, respectively, after the cycle life characteristic evaluation; and

FIG. 13 is a graph illustrating discharge capacity and coulombic efficiency according to the number of cycles of the full cells of Example 1 and Comparative Example 6.

### DETAILED DESCRIPTION OF THE INVENTION

According to the present disclosure, an anode active material for a secondary battery including a silicon-containing core and metal nanoparticles is provided. In addition, according to the present disclosure, a method of preparing an anode active material for a secondary battery, an anode for a secondary battery including the anode active material for a secondary battery, and a lithium secondary battery including the anode for a secondary battery are provided.

Hereinafter, the embodiments of the present disclosure will be described in detail with reference to the accompanying drawings. However, these embodiments are merely examples, and the present disclosure is not limited to the specific embodiments described as the examples.

The anode active material for a secondary battery according to the present disclosure includes a composite particle. The composite particle includes a core and metal nanoparticles arranged on the surface of the core. The core includes silicon.

The core may include silicon particles or silicon-based compound particles. For example, the core may include silicon particles, silicon oxide particles, silicon-carbon composite particles, etc. In one embodiment, the core may be substantially composed of silicon, and silicon may be included in an amount of 95% or more based on the total weight of the core.

According to exemplary embodiments, the core may have a median particle diameter (D50) of 1 μm to 5 μm. According to some embodiments, the core may have a median particle diameter (D50) of 1 μm to 4 μm. The “median particle diameter (D50)” refers to a median diameter (D50) of the particles, which may be defined as the particle diameter corresponding to 50% of the cumulative volume-based particle size distribution.

For example, the median particle diameter (D50) may be measured using a laser diffraction method. Specifically, the median particle diameter (D50) may be calculated by dispersing target particles in a dispersion medium, introducing the medium into a commercially available laser diffraction particle size measuring device (e.g., Microtrac MT 3000), irradiating ultrasonic waves at about 28 kHz with an output of 60 W, and then calculating the median particle diameter (D50) based on 50% of the cumulative volume-based particle size distribution with respect to the particle diameter in the measuring device.

The composite particle includes metal nanoparticles arranged on the outer surface of the core. The metal nanoparticles may be arranged on at least a portion of the outer surface of the core, and for example, may be uniformly attached to the entire outer surface of the core.

The composite particle may include the metal nanoparticles to compensate for the low electrical conductivity of the silicon-containing core.

Silicon may serve as an anode active material to implement a high-capacity anode, but its large volume change during charge and discharge cycles may deteriorate the cycle life characteristics of the battery. The composite particle may include highly ductile metal nanoparticles on the surface of the silicon-containing core particle, and may buffer the volume change of the anode during charge and discharge cycles. Accordingly, the cycle life characteristics of the battery may be improved.

According to exemplary embodiments, the metal nanoparticles may include silver (Ag), tin (Sn), aluminum (Al), bismuth (Bi), gold (Au), zinc (Zn), magnesium (Mg), antimony (Sb), lead (Pb), indium (In) and the like. In some embodiments, the metal may include silver (Ag), tin (Sn), gold (Au), indium (In), and the like, for example, the metal may include silver (Ag).

According to exemplary embodiments, the metal nanoparticles may have a median particle diameter of 10 nm to 200 nm. According to some embodiments, the metal nanoparticles may have a median particle diameter of 30 nm to 100 nm.

Within the above range, the electrical conductivity of the anode may be improved while preventing a decrease in the capacity.

According to exemplary embodiments, a ratio of the volume of the metal nanoparticles to the volume of the core is greater than 0.22 and 0.4 or less. According to some embodiments, the ratio of the volume of the metal nanoparticles to the volume of the core may be 0.23 to 0.4, 0.23 to 0.38, 0.23 to 0.35, 0.23 to 0.33, or 0.23 to 0.3.

Within the above range, the electrical conductivity of the electrode may be improved, and the surface resistance of the electrode may be reduced, as well as a battery having high-rate characteristics may be implemented. In addition, the cycle life characteristics of the battery may be improved, and a decrease in capacity may be prevented even during repeated charge and discharge cycles of the battery.

When the ratio of the volume of the metal nanoparticles to the volume of the core is 0.22 or less, the electrode volume change caused by the volume change of silicon may not be sufficiently buffered. Accordingly, the cycle life characteristics of the battery may be significantly degraded, and the capacity of the battery may rapidly decrease during repeated charge and discharge cycles of the battery.

If the ratio of the volume of the metal nanoparticles to the volume of the core exceeds 0.4, the content of silicon per unit volume of the anode active material may be relatively reduced, which may lead to a decrease in the capacity and energy density of the battery.

According to exemplary embodiments, the volume of the core may be 75% by volume (“vol %”) or more and less than 82 vol % based on the total volume of the composite particle. According to some embodiments, the volume of the core may be 75 vol % to 81 vol %, 75 vol % to 80 vol %, or 76 vol % to 80 vol % based on the total volume of the composite particle.

According to exemplary embodiments, the volume of the metal nanoparticles may be greater than 18 vol % and 25 vol % or less based on the total volume of the composite particle. According to some embodiments, the volume of the metal nanoparticles may be 19 vol % to 25 vol %, 20 vol % to 25 vol %, or 20 vol % to 24 vol % based on the total volume of the composite particle.

Within the above range, the electrical conductivity of the electrode may be further improved, and a battery having high-rate characteristics may be implemented. In addition, the cycle life characteristics of the battery may be further enhanced, and the capacity retention rate of the battery may be improved.

In accordance with the method of preparing an anode active material for a secondary battery according to the present disclosure, a silicon-containing core particle is introduced into an acid solution and subjected to surface etching. The metal nanoparticles may be firmly fixed on the surface of the core particles through the surface etching.

The core particle may be the same as the above-described core.

During surface etching, a portion of the silicon may be removed from the surface of the core particle. For example, silicon may be dissolved as a result of a reaction between the acid solution and silicon. As the silicon is dissolved, the surface roughness of the core particle may increase, thereby increasing the adhesion between the metal nanoparticles and the surface of the core particles.

According to exemplary embodiments, the acid solution may include hydrofluoric acid, nitric acid, hydrochloric acid, sulfuric acid, phosphoric acid, acetic acid and the like. According to some embodiments, the acid solution may include hydrofluoric acid and nitric acid.

According to exemplary embodiments, the pH of the acid solution may be 1 to 2. Accordingly, the surface of the core particle may be etched more quickly.

According to exemplary embodiments, the surface etching may be performed for 2 to 20 minutes. According to some embodiments, the surface etching may be performed for 2 to 15 minutes, or 3 to 10 minutes.

Within the above range, it is possible to prevent a decrease in the capacity of the electrode caused by excessive silicon removal from the core particle, and to prevent the generation of byproducts such as silicon peroxide.

The surface-etched core particle is introduced into a metal precursor solution to form metal nanoparticles thereon. When the surface-etched core particle is introduced into the metal precursor solution, metal nanoparticles may be formed thereon by electroless plating. Therefore, even without applying an additional energy, metal nanoparticles may be formed on the surface of the core particle by a potential difference of chemical species.

The metal precursor solution may include a metal precursor dissolved in water, and may further include an acid compound. For example, the acid compound may include a weak acid such as hydrofluoric acid. In this case, the reduction of the metal cations of the metal precursor may be accelerated, such that metal nanoparticles may be formed quickly.

According to exemplary embodiments, the metal precursor may include a metal nitrate, a metal sulfate, a metal hydroxide, a metal chloride, etc. For example, the metal precursor may include a metal nitrate.

According to exemplary embodiments, the metal may include silver (Ag), tin (Sn), aluminum (Al), bismuth (Bi), gold (Au), zinc (Zn), magnesium (Mg), antimony (Sb), lead (Pb), indium (In) and the like. In some embodiments, the metal may include silver (Ag), tin (Sn), gold (Au), indium (In), and the like, for example, the metal may include silver (Ag).

The metal precursor is introduced so that the ratio of the volume of the metal nanoparticles to the volume of the core is greater than 0.22 and 0.4 or less. According to some embodiments, the metal precursor may be introduced so that the ratio of the volume of the metal nanoparticles to the volume of the core is 0.23 to 0.4, 0.23 to 0.38, 0.23 to 0.35, 0.23 to 0.33, or 0.23 to 0.3.

Within the above range, the electrical conductivity of the electrode may be improved, and the surface resistance of the electrode may be reduced, as well as a battery having high-rate characteristics may be implemented. In addition, the cycle life characteristics of the battery may be improved, and a decrease in capacity may be prevented even during repeated charge and discharge cycles of the battery.

If a small amount of metal precursor is introduced so that the ratio of the volume of the metal nanoparticles to the volume of the core is 0.22 or less, the electrode volume change caused by the volume change of silicon may not be sufficiently buffered. Accordingly, the cycle life characteristics of the battery may be significantly degraded, and the capacity of the battery may decrease rapidly during charge and discharge cycles of the battery.

If an excessive amount of metal precursor is introduced so that the ratio of the volume of the metal nanoparticles to the volume of the core exceeds 0.4, the content of silicon per unit volume of the anode active material may be relatively reduced, which may lead to a decrease in the capacity and energy density of the battery.

The surface-etched core particle may be introduced into an aqueous metal precursor solution and left for 3 to 20 minutes to form metal nanoparticles thereon. According to some embodiments, the surface-etched core particle may be introduced into the metal precursor aqueous solution and left for 5 to 10 minutes to form metal nanoparticles thereon. The metal nanoparticles including metal may be formed by electroless plating without any additional treatment.

The anode for a secondary battery according to the present disclosure includes an anode current collector and an anode active material layer. The anode active material layer is disposed on one surface of the anode current collector. For example, the anode active material layers may also be disposed on both surfaces of the anode current collector.

Non-limiting examples of the anode current collector may include a copper foil, a nickel foil, a stainless steel foil, a titanium foil, a nickel foam, a copper foam, a polymer substrate coated with conductive metal and the like. The anode current collector may have a thickness of 10 μm to 50 μm, but it is not limited thereto.

The anode active material layer includes the above-described anode active material for a secondary battery and a binder. Accordingly, the amount of volume change of the anode active material layer may be reduced, and the cycle life characteristics of a battery including the anode may be improved.

As the binder, polyvinylidene fluoride (PVDF), poly(vinylidene fluoride-co-hexafluoropropylene) (PVDF-HFP) copolymer, polyacrylonitrile, polymethylmethacrylate, acrylonitrile butadiene rubber (NBR), polybutadiene rubber (BR), styrene-butadiene rubber (SBR)-based binder, carboxymethyl cellulose (CMC)-based, polyacrylic acid-based binder, poly(3,4-ethylenedioxythiophene, PEDOT)-based binder, etc. may be used.

The content of the binder may be 0.1 wt % to 3 wt % based on the total weight of the anode active material layer. Within the above range, the adhesion between the anode current collector and the anode active material layer may be improved, and the detachment of the anode active material from the anode active material layer may be reduced.

According to exemplary embodiments, the anode active material layer may further include a conductive material. The conductive material may be added to the anode active material layer in order to enhance the conductivity thereof and/or mobility of lithium ions or electrons. For example, the conductive material may further include a carbon-based conductive material such as graphite, carbon black, acetylene black, Ketjen black, graphene, vapor-grown carbon fibers (VGCFs), carbon fibers and/or a metal-based conductive material including tin, tin oxide, titanium oxide, or a perovskite material such as LaSrCoO₃, and LaSrMnO₃, but it is not limited thereto.

According to some embodiments, the anode active material layer may not include a carbon-based conductive material. The anode active material of the anode active material layer includes composite particles, and the composite particles include metal nanoparticles, such that the anode active material layer may exhibit sufficient electrical conductivity even without additional carbon-based conductive material. Accordingly, the content of the anode active material may be relatively increased, thereby enhancing the capacity of the anode.

The anode may be prepared by applying an anode slurry including an anode active material and a binder to an anode current collector, followed by drying and pressing the same.

The application may be performed using methods such as gravure coating, slot die coating, simultaneous multilayer die coating, imprinting, doctor blade coating, dip coating, bar coating or casting, but it is not limited thereto.

The anode slurry may include the anode active material, the binder and a solvent.

The solvent may include, for example, water, pure water, deionized water, distilled water, ethanol, isopropanol, methanol, acetone, n-propanol, t-butanol, etc.

The lithium secondary battery according to the present disclosure includes the anode for a secondary battery, a cathode disposed to face the anode, and a solid electrolyte layer interposed between the anode and the cathode.

The cathode may include a cathode current collector and a cathode active material layer disposed on at least one surface of the cathode current collector.

The cathode current collector may include stainless steel, nickel, aluminum, titanium, or an alloy thereof. The cathode current collector may also include aluminum or stainless steel subjected to surface treatment with carbon, nickel, titanium or silver. The cathode current collector may have a thickness of, for example, 10 μm to 50 μm, but it is not limited thereto.

The cathode active material layer may include a cathode active material. The cathode active material may include a compound capable of reversibly intercalating and deintercalating lithium ions.

According to exemplary embodiments, the cathode active material may include a lithium-nickel metal oxide. The lithium-nickel metal oxide may further include at least one of cobalt (Co), manganese (Mn) and aluminum (Al).

In some embodiments, the cathode active material or the lithium-nickel metal oxide may include a layered structure or a crystal structure represented by Formula 1 below.

LiₓNiₐM_{b}O_{2+z} [Formula 1]

In Formula 1, x, a, b and z may satisfy 0.9≤x≤1.2, 0.6≤a≤0.99, 0.01≤b≤0.4, −0.5≤z≤0.1. As described above, M may include Co, Mn, and/or Al.

The chemical structure represented by Formula 1 indicates a bonding relationship between elements included in the layered structure or crystal structure of the cathode active material, and does not exclude other additional elements. For example, M includes Co and/or Mn, and Co and/or Mn may be provided as main active elements of the cathode active material together with Ni. Here, it should be understood that Formula 1 is provided to express the bonding relationship between the main active elements, and is a formula encompassing introduction and substitution of the additional elements.

In one embodiment, the cathode active material may further include auxiliary elements which are added to the main active elements, thus to enhance chemical stability thereof or the layered structure/crystal structure. The auxiliary element may be incorporated into the layered structure/crystal structure together to form a bond, and it should be understood that this case is also included within the chemical structure range represented by Formula 1.

The auxiliary element may include, for example, at least one of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P or Zr. The auxiliary element may act as an auxiliary active element which contributes to the output activity of the cathode active material together with Co or Mn like Al.

For example, the cathode active material or the lithium-nickel metal oxide may include a layered structure or crystal structure represented by Formula 1 -1 below.

LiₓNiₐM1_{b1}M2_{b2}O_{2+z} [Formula 1-1]

In Formula 1-1, M1 may include Co, Mn, and/or Al. M2 may include the auxiliary elements described above. In Formula 1-1, x, a, b1, b2 and z may satisfy 0.9≤x≤1.2, 0.6≤a≤0.99, 0.01≤b1+b2≤0.4, −0.5≤z≤0.1.

The cathode active material may further include a coating element or a doping element. For example, elements which are substantially the same as or similar to the above-described auxiliary elements may be used as the coating element or the doping element. For example, the above-described elements may be used alone or in combination of two or more thereof as the coating element or the doping element.

The coating element or the doping element may exist on the surface of the lithium-nickel metal oxide particles, or may penetrate through the surface of lithium-nickel metal composite oxide particles to become incorporated into the bonding structure represented by Formula 1 or Formula 1 -1 above.

The cathode active material may include a nickel-cobalt-manganese (NCM)-based lithium oxide. In this case, an NCM-based lithium oxide with an increased content of nickel may be used.

Ni may be provided as a transition metal related to the output and capacity of the lithium secondary battery. Therefore, as described above, by employing a high-content (High-Ni) composition in the cathode active material, a high-capacity cathode and a high-capacity lithium secondary battery may be provided.

However, as the content of Ni is increased, long-term storage stability and cycle life stability of the cathode or the secondary battery may be relatively decreased, and a side reaction with the electrolyte may also be increased. However, according to exemplary embodiments, the cycle life stability and capacity retention characteristics may be improved through Mn while maintaining electrical conductivity by including Co.

The content of Ni (e.g., a molar fraction of nickel based on the total number of moles of nickel, cobalt and manganese) in the NCM-based lithium oxide may be 0.6 or more, 0.7 or more, or 0.8 or more. In some embodiments, the content of Ni may be 0.8 to 0.95, 0.82 to 0.95, 0.83 to 0.95, 0.84 to 0.95, 0.85 to 0.95, or 0.88 to 0.95.

In some embodiments, the cathode active material may include a lithium cobalt oxide-based active material, a lithium manganese oxide-based active material, a lithium nickel oxide-based active material, or a lithium iron phosphate (LFP) active material (e.g., LiFePO₄).

In some embodiments, the cathode active material may include a manganese (Mn)-rich active material, a lithium rich layered oxide (LLO)/over lithiated oxide (OLO)-based active material, or a cobalt (Co)-less active material, which have a chemical structure or crystal structure represented by Formula 2 below.

p[Li₂MnO₃].(1−p)[Li_{q}JO₂] [Formula 2]

n Formula 2, p and q may satisfy 0<p<1, 0.9≤q≤1.2, and J may include at least one element among Mn, Ni, Co, Fe, Cr, V, Cu, Zn, Ti, Al, Mg and B.

For example, the cathode active material may be dispersed in a solvent to prepare a cathode slurry. The cathode current collector may be coated with the cathode slurry, and then dried and pressed to prepare the cathode. The coating process may be performed using methods such as gravure coating, slot die coating, simultaneous multilayer die coating, imprinting, doctor blade coating, dip coating, bar coating or casting, etc., but it is not limited thereto. The cathode slurry may further include a binder, and optionally further include a conductive material, a thickener or the like.

Non-limiting examples of a solvent used in the preparation of the cathode slurry may include N-methyl-2-pyrrolidone (NMP), dimethylformamide, dimethylacetamide, N,N-dimethylaminopropylamine, ethylene oxide, tetrahydrofuran and the like.

The binder may include polyvinylidene fluoride (PVDF), poly(vinylidene fluoride-co-hexafluoropropylene) (PVDF-HFP), polyacrylonitrile, polymethylmethacrylate, acrylonitrile butadiene rubber (NBR), polybutadiene rubber (BR), styrene-butadiene rubber (SBR), etc. In one embodiment, a PVDF-based binder may be used as the cathode binder.

The conductive material may be added to the cathode active material layer in order to enhance the conductivity thereof and/or the mobility of lithium ions or electrons. For example, the conductive material may further include a carbon-based conductive material such as graphite, carbon black, acetylene black, Ketjen black, graphene, vapor-grown carbon fibers (VGCFs), carbon fibers and/or a metal-based conductive material including tin, tin oxide, titanium oxide, or a perovskite material such as LaSrCoO₃, and LaSrMnO₃, but it is not limited thereto.

The cathode slurry may further include a thickener and/or a dispersant, etc., as necessary. In one embodiment, the cathode slurry may include a thickener such as carboxymethyl cellulose (CMC).

The solid electrolyte layer may include an inorganic solid electrolyte. The lithium secondary battery may be configured as an all-solid-state battery, and the solid electrolyte layer may physically separate the anode from the cathode.

The inorganic solid electrolyte may include a sulfide-based electrolyte. As a non-limiting example, the sulfide-based electrolyte may include Li₂S—P₂S₅, Li₂S—P₂S₅—LiCl, Li₂S—P₂S₅—LiBr, Li₂S—P₂S₅—LiCl—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—ZmSn (m, n are positive numbers, Z is Ge, Zn or Ga), Li₂S—GeS₂, Li₂S—SiS₂—Li₃PO₄, Li₂S—SiS₂—LipMOq, (p, q are positive numbers, M is P, Si, Ge, B, Al, Ga or In), Li₇₋ₓPS₆₋ₓClₓ (0≤x≤2), Li₇₋ₓPS₆₋ₓBrₓ (0≤x≤2), Li₇₋ₓPS₆₋ₓIₓ (0≤x≤2), etc. These may be used alone or in combination of two or more thereof.

In one embodiment, the inorganic solid electrolyte may include an oxide-based solid electrolyte, such as, for example, Li₂O—B₂O₃—P₂O₅, Li₂O—SiO₂, Li₂O—B₂O₃, Li₂O—B₂O₃—ZnO, etc.

For example, the oxide-based inorganic electrolyte may include a garnet-type compound, a NASICON-type compound, a perovskite-type compound, etc. These may be used alone or in combination of two or more thereof.

The garnet-type compound is a compound having a garnet crystal structure or a garnet-like crystal structure, and may include, for example, an LLZO-based compound.

The LLZO-based compound may be an oxide containing lithium, lanthanum and zirconium. The LLZO-based compound may further include Al, Ga, In, Sc, Ba, Nb, etc., and may include, for example, Li₇La₃Zr₂O₁₂, etc.

The NASICON-type compound is a compound having a NASICON crystal structure or a NASICON-like crystal structure, and may include, for example, a LATP-based compound, a LAGP-based compound, etc.

The LATP-based compound may be a phosphate including lithium, aluminum and titanium, and may include, for example, Li_{1.3}Al_{0.3}Ti_{1.7}(PO₄)₃, etc.

The LAGP-based compound may be a phosphate containing lithium, aluminum and germanium, and may include, for example, Li_{1.5}Al_{0.5}Ge_{1.5}(PO₄)₃, etc.

The perovskite-type compound is a compound having a perovskite crystal structure or a perovskite-like crystal structure, and may include, for example, an LLTO-based compound.

The LLTO-based compound may be an oxide containing lithium, lanthanum and titanium, and may include, for example, Li_{0.31}La_{0.56}TiO₃, etc.

According to exemplary embodiments, the cathode, the anode and the solid electrolyte layer may be repeatedly disposed to form an electrode assembly. In some embodiments, the electrode assembly may be of a winding type, a stacking type, a z-folding type, or a stack-folding type.

For example, electrode tabs (a cathode tab and an anode tab) may protrude from the cathode current collector and the anode current collector, respectively, and may extend to one side of a case. The electrode tabs may be fused together with the one side of the case and connected to electrode leads (a cathode lead and an anode lead) that extend or are exposed to the outside of the case.

For example, a pouch-type case, a prismatic case, a cylindrical case, a coin-type case, etc. may be used.

Hereinafter, embodiments of the present disclosure will be further described with reference to specific experimental examples. However, the following examples and comparative examples included in the experimental examples are only given for illustrating the present disclosure and those skilled in the art will obviously understand that various alterations and modifications are possible within the scope and spirit of the present disclosure. Such alterations and modifications are duly included in the appended claims.

### EXAMPLE 1

### Preparation of Anode Active Material

2 g of silicon particles (D50: 1-5 μm) were introduced into a mixed acid solution consisting of 8 ml of hydrofluoric acid, 40 ml of nitric acid and 80 ml of deionized water, and the mixture was subjected to surface etching the silicon particles for 4 minutes. 1 g of the surface-etched silicon particles and 1.52 g of silver nitrate (AgNO₃) were added to a mixed aqueous solution consisting of 8 ml of hydrofluoric acid and 250 ml of deionized water, and the mixture was treated for 7 minutes to form silver nanoparticles on the surface of the silicon particles. Among the manufactured composite particles, the ratio of the volume of the silver nanoparticles to the volume of the core was 0.28 (core=78 vol %, silver nanoparticles=22 vol %).

### Preparation of Anode

An anode slurry was prepared by mixing the anode active material and polyvinylidene fluoride (PVDF) in a weight ratio of 99:1 and dispersing the mixture in N-methylpyrrolidone as a solvent. The anode slurry was cast onto one surface of a copper current collector using a doctor blade. Thereafter, the current collector was vacuum-dried at room temperature (25° C.) for 1 hour, and then heated to 80° C. under the vacuum and dried for 12 hours or more.

### Manufacture of All-Solid-State Half-Cell

150 mg of Li₆PS₅Cl as a solid electrolyte was loaded into a mold cell, and then compressed at a pressure of 70 MPa to form a pellet.

The anode was loaded onto one surface of the solid electrolyte pellet, and 100 mg of an electrode prepared by mixing Li_{0.5}In and the solid electrolyte in a weight ratio of 8:2 was loaded onto the other surface, and then pressed at 370 MPa for 3 minutes to manufacture an all-solid-state half-cell. The cell was fastened to apply a driving pressure of 15 MPa and sealed to prevent air from entering the cell during the evaluation of the all-solid-state half-cell.

### EXAMPLE 2

An anode active material, an anode, and an all-solid-state half-cell were manufactured in the same manner as in Example 1, except that the surface etching was performed for 10 minutes. The ratio of the volume of the nanoparticles to the core volume was 0.28 (core=78 vol %, silver nanoparticles=22 vol %).

### EXAMPLE 3

An anode active material, an anode, and an all-solid-state half-cell were manufactured in the same manner as in Example 1, except that the surface etching was performed for 20 minutes. The ratio of the volume of nanoparticles to the core volume was 0.28 (core=78 vol %, silver nanoparticles=22 vol %).

### EXAMPLE 4

An anode active material, an anode, and an all-solid-state half-cell were manufactured in the same manner as in Example 1, except that the amount of silver nitrate used was adjusted so that the ratio of the volume of the silver nanoparticles to the volume of the core among the composite particles was 0.25.

### COMPARATIVE EXAMPLE 1

An anode active material was prepared by mixing 2 g of silicon particles (D50: 1-5 μm) and 2.32 g of silver particles (150 nm), and ball milling at 2000 rpm for 5 minutes.

An anode and an all-solid-state half-cell were manufactured in the same manner as in Example 1, except that the above-prepared anode active material was used.

### COMPARATIVE EXAMPLE 2

An anode active material, an anode, and an all-solid-state half-cell were manufactured in the same manner as in Example 1, except that silicon particles were used as the anode active material.

### COMPARATIVE EXAMPLE 3

An anode active material, an anode, and an all-solid-state half-cell were manufactured in the same manner as in Example 1, except that the amount of silver nitrate used was adjusted so that the ratio of the volume of the silver nanoparticles to the volume of the core among the composite particles was 0.11.

### COMPARATIVE EXAMPLE 4

An anode active material, an anode, and an all-solid-state half-cell were manufactured in the same manner as in Example 1, except that the amount of silver nitrate used was adjusted so that the ratio of the volume of the silver nanoparticles to the volume of the core among the composite particles was 0.22.

### COMPARATIVE EXAMPLE 5

An anode active material, an anode, and an all-solid-state half-cell were manufactured in the same manner as in Example 1, except that the amount of silver nitrate used was adjusted so that the ratio of the volume of the silver nanoparticles to the volume of the core among the composite particles was 0.43.

### COMPARATIVE EXAMPLE 6

An anode active material, an anode, and an all-solid-state half-cell were manufactured in the same manner as in Example 1, except that an anode slurry was prepared by mixing silicon particles, carbon black, and PVDF in a weight ratio of 90:5:5 and dispersing the mixture in N-methylpyrrolidone as a solvent.

### EXPERIMENTAL EXAMPLE 1: SEM-EDS ANALYSIS

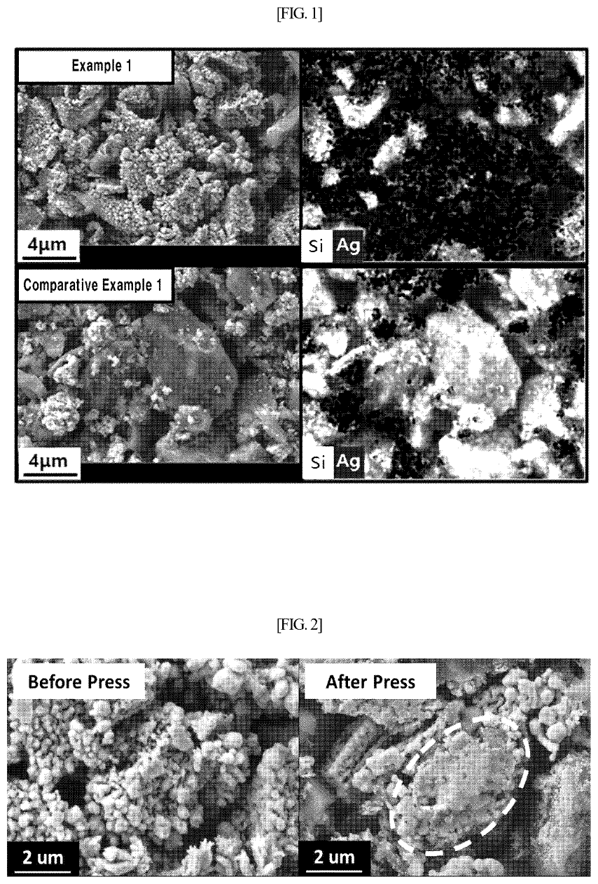

FIG. 1 is scanning electron microscope (SEM) images illustrating the anode active materials of Example 1 and Comparative Example 1 and elemental EDS mapping images of silicon and silver.

Referring to FIG. 1, the silver nanoparticles on the surface of the anode active material of Example 1 were formed in a form where they are uniformly dispersed on the surface of the silicon core. Accordingly, the area where silicon was observed in the image of the anode active material of Example 1 was smaller than that observed in the image of the anode active material of Comparative Example 1.

### EXPERIMENTAL EXAMPLE 2: COMPRESSION EVALUATION

The anode of Example 1 was compressed at a pressure of 370 MPa for about 3 minutes.

FIG. 2 is SEM images illustrating the anode of Example 1 before and after compression.

Referring to FIG. 2, as shown in the image after compression, when the anode of Example 1 was compressed, the silver nanoparticles were transformed into a form that filled the gaps between the core particles and were arranged more densely on the surface of the cores.

### EXPERIMENTAL EXAMPLE 3: XRD ANALYSIS

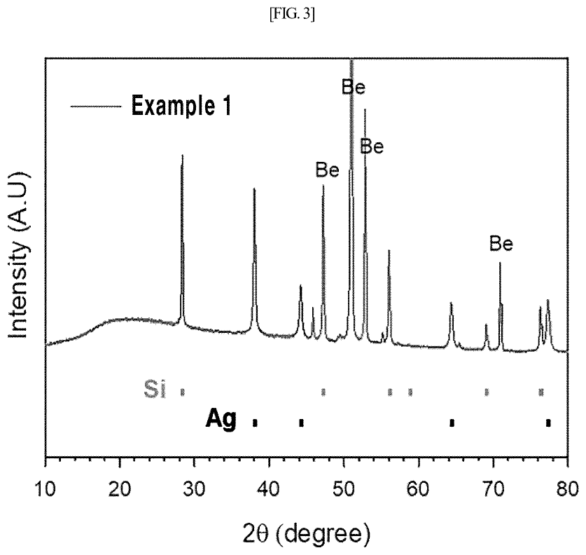

FIG. 3 is a graph illustrating X-ray diffraction (XRD) analysis results of the anode active material of Example 1.

Referring to FIG. 3, peaks corresponding to silver and silicon were identified from the XRD analysis results of the anode active material of Example 1.

### EXPERIMENTAL EXAMPLE 4: EVALUATION OF ELECTRICAL CONDUCTIVITY CHARACTERISTICS OF ELECTRODE

The electrical conductivities and surface resistances of the anodes of Example 1 and Comparative Example 2 were measured using the four-point probe method.

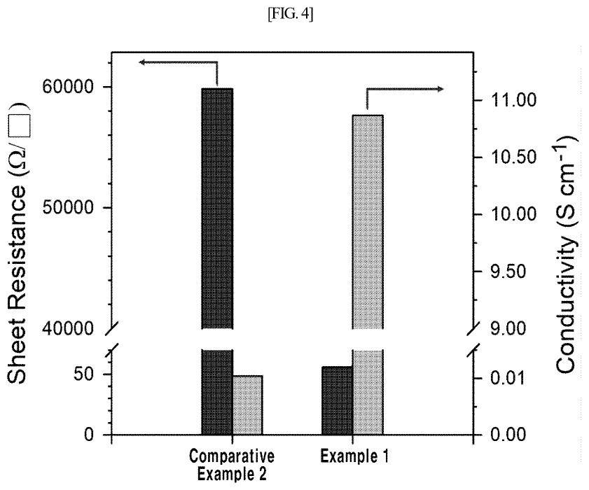

FIG. 4 is a graph illustrating the electrical conductivity and surface resistance of the anodes of Example 1 and Comparative Example 2.

Referring to FIG. 4, the surface resistance of the anode of Example 1 decreased and its electrical conductivity was improved.

### EXPERIMENTAL EXAMPLE 5: EVALUATION OF HALF-CELL CYCLE LIFE CHARACTERISTICS

The all-solid-state half-cells of Examples 1 to 3 and Comparative Examples 3 or 4 were charged at a C-rate of 0.2 C until the voltage reached 0.01 V (vs. Li), and then were cut off at 0.01 V (vs. Li). Subsequently, the cells were discharged at a C-rate of 0.2 C until the voltage reached 1.0 V (vs. Li). The charge and discharge were repeated for 100 cycles, with one cycle consisting of the above-described charge and discharge processes, and the discharge capacity was measured.

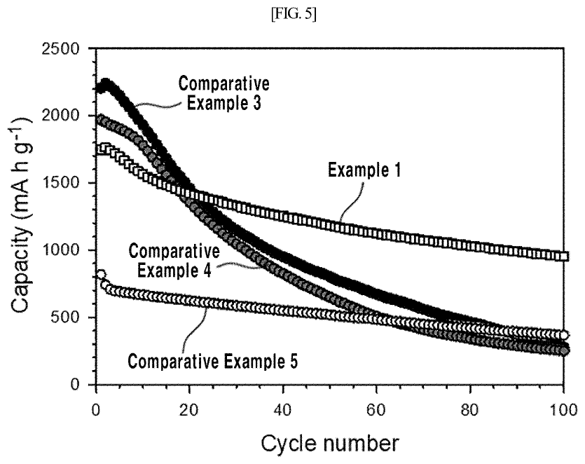

FIG. 5 is a graph illustrating the discharge capacity according to the number of cycles of the all-solid-state half-cells of Example 1 and Comparative Examples 3 to 5.

Referring to FIG. 5, in the half-cell of Example 1, the discharge capacity was maintained at about 57% of the initial discharge capacity even after 100 charge and discharge cycles. In contrast, the discharge capacities of the half-cells of Comparative Examples 3 to 5 rapidly decreased to less than 30% of the initial discharge capacity after 100 cycles.

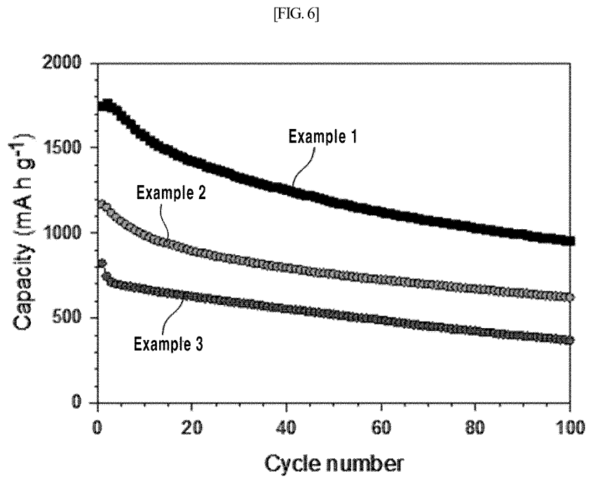

FIG. 6 is a graph illustrating the discharge capacity according to the number of cycles of the half-cells of Examples 1 to 3.

Referring to FIG. 6, among the half-cells of the examples, the anode of Example 1, which included the anode active material prepared using core particles subjected to an appropriate etching time, exhibited the highest initial capacity.

### EXPERIMENTAL EXAMPLE 6: EVALUATION OF ELECTROCHEMICAL PROPERTIES OF ALL-SOLID-STATE HALF-CELL

### (1) Evaluation of Coulombic Efficiency

The all-solid-state half-cells of Example 1 and Comparative Example 6 were charged at a C-rate of 0.2 C until the voltage reached 0.01 V (vs. Li), and then were cut off at 0.01 V (vs. Li). Subsequently, the cells were discharged at a C-rate of 0.2 C until the voltage reached 1.0 V (vs. Li), and the voltage was measured as a function of the capacity.

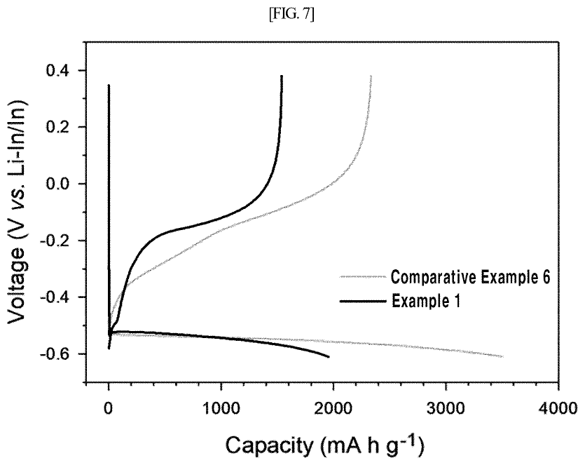

FIG. 7 is a graph illustrating capacity-voltage curves of the all-solid-state half-cells of Example 1 and Comparative Example 6.

Referring to FIG. 7, the initial coulombic efficiency of the half-cell of Example 1 was 76%, whereas the initial coulombic efficiency of the half-cell of Comparative Example 6 was lower at 66%.

### (2) Evaluation of Rate Characteristic

The all-solid-state half-cells of Example 1 and Comparative Example 6 were charged at a C-rate of 0.05 C until the voltage reached 0.01 V (vs. Li), and then were cut off at 0.01 V (vs. Li). Subsequently, the cells were discharged at a C-rate of 0.05 C until the voltage reached 1.0 V (vs. Li).

The charge and discharge were repeated for 3 cycles, with one cycle consisting of the above-described charge and discharge processes, and then sequentially repeated for 3 cycles each at c-rates of 0.1 C, 0.2 C, 0.5 C, 1.0 C and 0.2 C, to measure the discharge capacity of the half-cell.

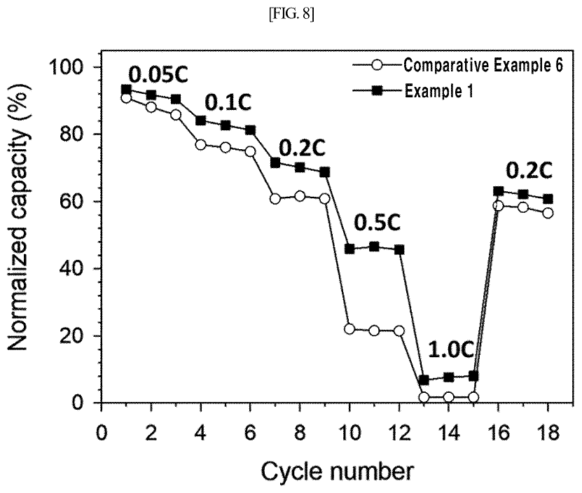

FIG. 8 is a graph illustrating the rate evaluation results according to the number of cycles of the all-solid-state half-cells of Example 1 and Comparative Example 6.

Referring to FIG. 8, the all-solid-state half-cell of Example 1 exhibited improved rate characteristics than the all-solid-state half-cell of Comparative Example 6.

### (3) Evaluation of Cycle Life Characteristic

The all-solid-state half-cells of Example 1 and Comparative Example 6 were charged at a C-rate of 0.2 C until the voltage reached 0.01 V (vs. Li), and then were cut off at 0.01 V (vs. Li). Subsequently, the cells were discharged at a C-rate of 0.2 C until the voltage reached 1.0 V (vs. Li). The charge and discharge were repeated for 100 cycles, with one cycle consisting of the above-described charge and discharge processes, and the discharge capacity was measured.

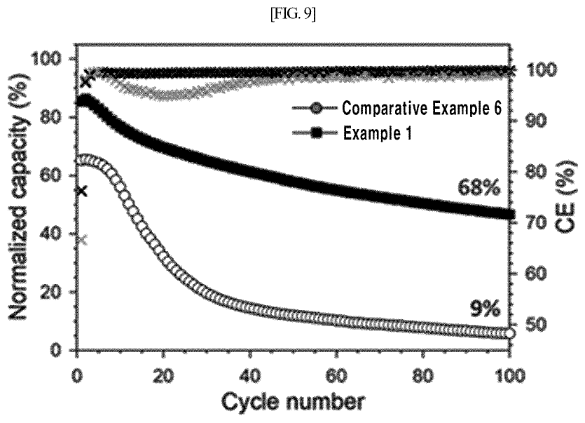

FIG. 9 is a graph illustrating the discharge capacity and coulombic efficiency according to the number of cycles of the all-solid-state half-cells of Example 1 and Comparative Example 6.

Referring to FIG. 9, in the all-solid-state half-cell of Example 1, the coulombic efficiency was maintained at about 100% even after 100 cycles, and the capacity retention rate was higher at 68%. On the other hand, the all-solid-state half-cell of Comparative Example 6 exhibited significantly deteriorated cycle life characteristics, with a capacity retention rate of 9% after 100 cycles.

### EXPERIMENTAL EXAMPLE 7: EVALUATION OF INTERFACE AFTER HALF-CELL EVALUATION

### (1) XPS Analysis

The all-solid-state half-cells of Example 1 and Comparative Example 6 were charged at a C-rate of 0.05 C until the voltage reached 0.01 V (vs. Li), and then were cut off at 0.01 V (vs. Li). Subsequently, the cells were discharged at a C-rate of 0.05 C until the voltage reached 1.0 V (vs. Li).

Thereafter, the solid electrolyte was separated from the half-cell, and the interface that had been in contact with the anode was analyzed by X-ray photoelectron spectroscopy (XPS) using a K-alpha model XPS (mono) from Thermo U. K.

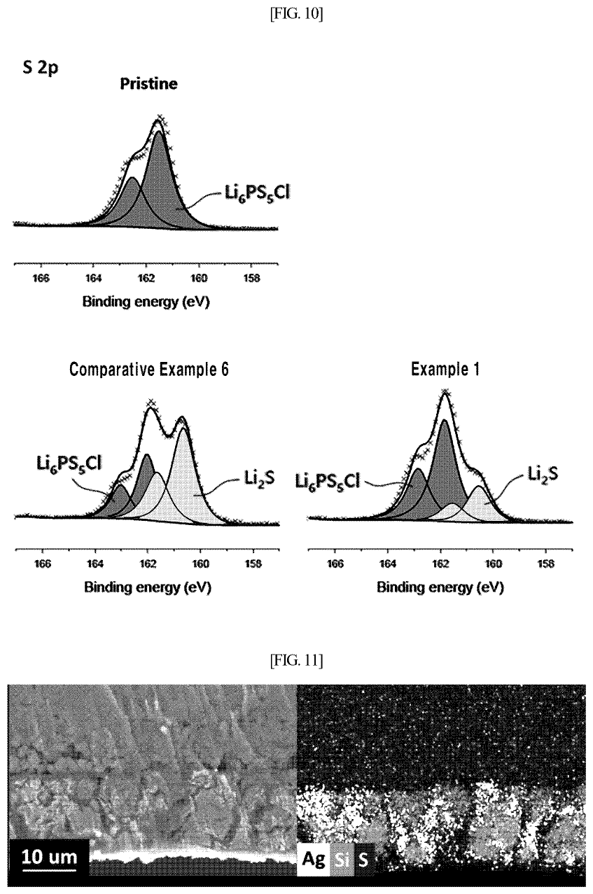

FIG. 10 is graphs illustrating the XPS analysis results of the surface of the solid electrolyte layer after the cycle life characteristic evaluation of the solid electrolyte layers and the all-solid-state half-cells of Example 1 and Comparative Example 6.

Referring to FIG. 10, Li₂S, a decomposition byproduct of the solid electrolyte, was generated in a larger amount on the surface of the solid electrolyte layer of Comparative Example 6 than on the surface of the solid electrolyte layer of Example 1. From this result, it can be confirmed that the decomposition of the solid electrolyte on the surface of the anode of Example 1 was suppressed, thereby increasing the coulombic efficiency of the battery.

### (2) Interface SEM Analysis

During the cycle life characteristic evaluation described in (3) of Experimental Example 6, after 40 cycles, the solid electrolyte and anode were separated while maintaining the bonded state, and the cross-section was cut and analyzed using SEM and EDS.

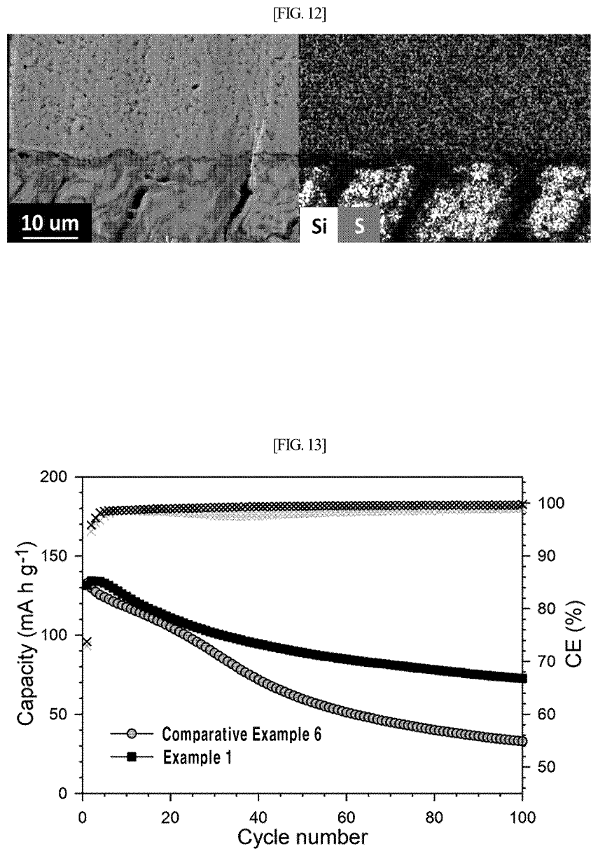

FIGS. 11 and 12 show SEM cross-sectional images and EDS analysis results of the anode-solid electrolyte assemblies of Example 1 and Comparative Example 6, respectively, after the cycle life characteristic evaluation.

Referring to FIGS. 11 and 12, no vertical cracks were observed in the anode of Example 1, and the lithium ion pathways within the electrode remained intact. In contrast, vertical cracks were observed in the anode of Comparative Example 6.

### EXPERIMENTAL EXAMPLE 8: EVALUATION OF FULL CELL

A cathode composition was prepared by mixing LiNi_{0.7}Co_{0.15}Mn_{0.15}O₂ as a cathode active material, a solid electrolyte, and carbon black as a conductive material in a weight ratio of 70:30:3.

150 mg of Li₆P_{S}5Cl as a solid electrolyte was loaded into a mold cell, and then compressed at a pressure of 70 MPa into a pellet.

The anodes of Example 1 or Comparative Example 6 were loaded onto one surface of the solid electrolyte pellet, and 20 mg of the cathode composition was loaded onto the other surface, then pressed at 370 MPa for 3 minutes to manufacture an all-solid-state battery. The battery was fastened to apply a driving pressure of 15 MPa and sealed to prevent air from entering the battery.

The battery was charged at a C-rate of 0.2 C until the voltage reached 0.01 V (vs. Li), and then were cut off at 0.01 V (vs. Li). Subsequently, the battery was discharged at a C-rate of 0.2 C until the voltage reached 1.0 V (vs. Li).

The charge and discharge were repeated for 100 cycles, with one cycle consisting of the above-described charge and discharge processes, and the discharge capacity and coulombic efficiency were measured.

FIG. 13 is a graph illustrating the discharge capacity and coulombic efficiency according to the number of cycles of the full cells of Example 1 and Comparative Example 6.

Referring to FIG. 13, the capacity retention rate after 100 cycles in the full cell of Example 1 was about 55%, whereas the capacity retention rate after 100 cycles in the full cell of Comparative Example 6 was significantly lower at 25%.

The contents described above are merely examples of applying the principles of the present disclosure, and other configurations may be further included without departing from the scope of the present disclosure.

What is claimed is:

1. An anode active material for a secondary battery comprising:
a composite particle comprising:
a core comprising silicon; and
metal nanoparticles arranged on an outer surface of the core,
wherein a ratio of a volume of the metal nanoparticles to a volume of the core is greater than 0.22 and 0.4 or less.

2. The anode active material for a secondary battery according to claim 1, wherein the ratio of the volume of the metal nanoparticles to the volume of the core is 0.23 to 0.4.

3. The anode active material for a secondary battery according to claim 1, wherein the volume of the core is 75% by volume or more and 82% by volume or less based on the total volume of the composite particle.

4. The anode active material for a secondary battery according to claim 1, wherein the volume of the metal nanoparticles is greater than 18% by volume and 25% by volume or less based on the total volume of the composite particle.

5. The anode active material for a secondary battery according to claim 1, wherein the metal nanoparticles comprise at least one selected from the group consisting of silver (Ag), tin (Sn), aluminum (Al), bismuth (Bi), gold (Au), zinc (Zn), magnesium (Mg), antimony (Sb), lead (Pb) and indium (In).

6. The anode active material for a secondary battery according to claim 1, wherein the metal nanoparticles have a median particle diameter (D50) of 10 nm to 200 nm.

7. The anode active material for a secondary battery according to claim 1, wherein the core has a median particle diameter (D50) of 1 μm to 5 μm.

8. A method of preparing an anode active material for a secondary battery comprising:
introducing a silicon-containing core particle into an acid solution to perform surface etching; and
introducing the surface-etched core particle into an aqueous metal precursor solution to form metal nanoparticles on a surface of the core particle,
wherein a ratio of a volume of the metal nanoparticles to the volume of the core is greater than 0.22 and 0.4 or less.

9. The method of preparing an anode active material for a secondary battery according to claim 8, wherein the surface etching is performed for 2 minutes to 20 minutes.

10. The method of preparing an anode active material for a secondary battery according to claim 8, wherein a pH of the acid solution is 1 to 2.

11. The method of preparing an anode active material for a secondary battery according to claim 8, wherein the acid solution comprises at least one selected from the group consisting of hydrofluoric acid, nitric acid, hydrochloric acid, sulfuric acid, phosphoric acid and acetic acid.

12. The method of preparing an anode active material for a secondary battery according to claim 8, wherein the metal precursor comprises at least one selected from the group consisting of a metal nitrate, a metal sulfate, a metal hydroxide, and a metal chloride.

13. An anode for a secondary battery comprising:
an anode current collector; and
an anode active material layer disposed on one surface of the anode current collector and comprising the anode active material for a secondary battery according to claim 1 and a binder.

14. The anode for a secondary battery according to claim 13, wherein the anode active material layer does not include a carbon-based conductive material.

15. A lithium secondary battery comprising:
the anode for a secondary battery according to claim 13;
a cathode disposed to face the anode; and
a solid electrolyte layer interposed between the anode and the cathode.
